(19) United States
(12) Patent Application Publication
(10) Pub. No.: US 2020/0157411 A1
(43) Pub. Date: May 21, 2020

(54) ALCOHOL ALKOXY SULFATE COMPOSITION

(71) Applicant: SHELL OIL COMPANY, Houston, TX (US)

(72) Inventors: David PEREZ-REGALADO, Amsterdam (NL); Timothy Elton KING, Katy, TX (US); Julian Richard BARNES, Amsterdam (NL)

(21) Appl. No.: 16/682,046

(22) Filed: Nov. 13, 2019

Related U.S. Application Data
(60) Provisional application No. 62/768,127, filed on Nov. 16, 2018.

(51) Int. Cl. C09K 8/584; C09K 8/588; B01F 17/00; E21B 43/16

(52) U.S. Cl. CPC C09K 8/584; E21B 43/162; B01F 17/0057; C09K 8/588

(57) ABSTRACT

A composition comprising from 60-80 wt % alcohol alkoxy sulfates, 2-20 wt % of polyalkoxy sulfates and water wherein the alcohol alkoxy sulfates are of the formula R—O—(C₃H₆O)ₓ—(C₂H₄O)_{y}—SO₃ where R is an alkyl group having from 9 to 18 carbon atoms, x is from 1 to 40, y is from 0 to 20 and x+y is from 1 to 60.

### CROSS-REFERENCE TO RELATED APPLICATION

This application claims the benefit of the U.S. Provisional Patent Application 62/768,127 filed Nov. 16, 2018 entitled AN ALCOHOL ALKXY SULFATE COMPOSITION, the entirety of which is incorporated by reference herein.

### FIELD OF THE INVENTION

The invention relates to an alcohol alkoxy sulfate composition, a method of producing that composition and a use of that composition.

### BACKGROUND

Hydrocarbons may be recovered from hydrocarbon containing formations (or reservoirs) by penetrating the formation with one or more wells, which may allow the hydrocarbons to flow to the surface. A hydrocarbon containing formation may have one or more natural components that may aid in mobilizing hydrocarbons to the surface of the wells. For example, gas may be present in the formation at sufficient levels to exert pressure on the hydrocarbons to mobilize them to the surface of the production wells. These are examples of so-called “primary oil recovery”.

However, reservoir conditions (for example permeability, hydrocarbon concentration, porosity, temperature, pressure, composition of the rock, concentration of divalent cations (or hardness), etc.) can significantly impact the economic viability of hydrocarbon production from any particular hydrocarbon containing formation.

Furthermore, the above-mentioned natural pressure-providing components may become depleted over time, often long before the majority of hydrocarbons have been extracted from the reservoir. Therefore, supplemental recovery processes may be required and used to continue the recovery of hydrocarbons from the hydrocarbon containing formation. This supplemental oil recovery is often called “secondary oil recovery” or “tertiary oil recovery”. Examples of known supplemental processes include waterflooding, polymer flooding, gas flooding, alkali flooding, thermal processes, solution flooding, solvent flooding, or combinations thereof. Various surfactants may be used in these supplemental processes, but some surfactants are less effective under certain reservoir conditions.

Surfactants are typically manufactured in one location and transported to the location of the hydrocarbon formation. It is preferred to transport more concentrated surfactant compositions, also known as high active matter compositions, but higher active matter compositions tend to have higher viscosity. It would be desirable to use a high active matter surfactant composition that had a suitably low viscosity to allow for transportation, pumping and storage.

### SUMMARY OF THE INVENTION

The invention provides a composition comprising from 60-80 wt % alcohol alkoxy sulfates, 2-20 wt % of polyalkoxy sulfates and water wherein the alcohol alkoxy sulfates are of the formula R—O—(C₃H₆O)ₓ—(C₂H₄O)_{y}—SO₃ where R is an alkyl group having from 9 to 18 carbon atoms, x is from 1 to 40, y is from 0 to 20 and x+y is from 1 to 60.

The invention provides a method of producing the composition of claim 1 comprising sulfating an alcohol alkoxylate by contacting the alcohol alkoxylate with a sulfating agent under sulfation conditions wherein the sulfation conditions comprise feeding the sulfating agent at a molar ratio of SO₃ to alcohol alkoxylate of greater than 1:1.

The invention provides a method of treating a hydrocarbon containing formation comprising providing a hydrocarbon recovery composition to at least a portion of the hydrocarbon containing formation and allowing the hydrocarbon recovery composition to contact the formation wherein the hydrocarbon recovery composition comprises a mixture of: a) 0.05 to 2 wt % of a composition comprising from 60-80 wt % alcohol alkoxy sulfates and 2-20 wt % of polyalkoxy sulfates wherein the alcohol alkoxy sulfates are of the formula R—O—(C₃H₆O)ₓ(C₂H₄O)_{y}—SO₃ where R is an alkyl group having from 9 to 18 carbon atoms, x is from 1 to 40, y is from 0 to 20 and x+y is from 1 to 60; and b) 60 to 98 wt % water and/or brine.

### DETAILED DESCRIPTION OF THE INVENTION

The invention provides an alcohol alkoxy sulfate composition that has a high active matter while exhibiting a sufficiently low viscosity that it is still pumpable and easy to handle. Active matter means the total of anionic species in the aqueous surfactant composition, but excluding any inorganic anionic species, for example, sodium sulfate. High active matter compositions have less water, so the same amount of active surfactant can be more cheaply transported due to the lower total volume of material. The alcohol alkoxy sulfate is made by alkoxylating an alcohol and then sulfating the alkoxylated alcohol as described herein.

Alcohol and Method of Manufacture

The R group in the starting alcohol R—OH is the same R group as in the resulting alcohol alkoxy sulfate. The R group is preferably aliphatic, and it may be an alkyl group, cycloalkyl group or alkenyl group. The R group is preferably an alkyl group. The R group may be substituted by another hydrocarbyl group or by a substituent which contains one or more heteroatoms, for example a hydroxy group or an alkoxy group.

The alcohol may be an alcohol containing 1 hydroxyl group (mono-alcohol) or an alcohol containing from 2 to 6 hydroxyl groups (poly-alcohol). Suitable examples of poly-alcohols are diethylene glycol, dipropylene glycol, glycerol, pentaerythritol, trimethylolpropane, sorbitol and mannitol. The alcohol is preferably a mono-alcohol. Further, the alcohol may be a primary or secondary alcohol, preferably a primary alcohol.

The alcohol may comprise a range of different molecules which may differ from one another in terms of carbon number for the R group, the R group being branched or unbranched, the number of branches for the R group, and the molecular weight. Generally, the R group may be a branched hydrocarbyl group or an unbranched (linear) hydrocarbyl group.

The R group has a weight average carbon number within a wide range, namely 5 to 32, preferably 6 to 25, more preferably 7 to 22, most preferably 8 to 20. In another embodiment, the weight average carbon number is 9 to 18. In a case where the alkyl group contains 3 or more carbon atoms, the alkyl group is attached either via its terminal carbon atom or an internal carbon atom to the oxygen atom, preferably via its terminal carbon atom. Further, the weight average carbon number of the alkyl group is at least 5, preferably at least 6, more preferably at least 7, more preferably at least 8, more preferably at least 9, more preferably at least 10, more preferably at least 11, most preferably at least 12. Still further, the weight average carbon number of the alkyl group is at most 32, preferably at most 25, more preferably at most 20, more preferably at most 18, more preferably at most 16, more preferably at most 15, more preferably at most 14, most preferably at most 13. The weight average carbon number may be in a range of from 9 to 13.

In one embodiment, the R group is preferably a largely branched alkyl group which has a branching index equal to or greater than 0.15. The branching index is determined by dividing the total number of branches by the total number of molecules. The branching index can be determined by ¹H-NMR analysis. The branching index of the R group is preferably of from 0.3 to 3.0, most preferably 1.2 to 1.4. Further, the branching index is at least 0.3, preferably at least 0.5, more preferably at least 0.7, more preferably at least 0.9, more preferably at least 1.0, more preferably at least 1.1, most preferably at least 1.2. Still further, the branching index is preferably at most 3.0, more preferably at most 2.5, more preferably at most 2.2, more preferably at most 2.0, more preferably at most 1.8, more preferably at most 1.5, most preferably at most 1.3.

In another embodiment, the R group is preferably a largely linear alkyl group which has a branching index of about 0.2. Alcohols having largely linear R groups may be alcohols based on the modified OXO hydroformylation process where an olefin is converted to an alcohol.

The alcohol may be prepared in any way. For example, a primary aliphatic alcohol may be prepared by hydroformylation of a branched olefin. Preparations of branched olefins are described in U.S. Pat. Nos. 5,510,306; 5,648,584 and 5,648,585. Preparations of branched long chain aliphatic alcohols are described in U.S. Pat. Nos. 5,849,960; 6,150,222; 6,222,077. In another embodiment, the alcohols may be obtained by the Ziegler process.

Alcohols as described above are commercially available. A suitable example of a commercially available alcohol mixture is NEODOL™ 67, which includes a mixture of C₁₆ and C₁₇ alcohols of the formula R—OH, wherein R is a branched alkyl group having a branching index of about 1.3, sold by Shell Chemical LP. NEODOL™ as used throughout this text is a trademark. Shell Chemical LP also manufactures a C₁₂/C₁₃ analogue alcohol of NEODOL™ 67, which includes a mixture of C₁₂ and C₁₃ alcohols of the formula R—OH, wherein R is a branched alkyl group having a branching index of about 1.3. Other suitable examples from Shell Chemical LP include NEODOL™ 91 and NEODOL™ 23 wherein R is a branched alkyl group having a branching index of about 0.2. Another suitable example is EXXAL™ 13 tridecylalcohol (TDA), sold by ExxonMobil, which is of the formula R—OH wherein R is a branched alkyl group having a branching index of about 2.9 and having a carbon number distribution wherein 30 wt. % is C₁₂, 65 wt. % is C₁₃ and 5 wt. % is C₁₄. Yet another suitable example is MARLIPAL® tridecylalcohol (TDA), sold by Sasol, which is of the formula R—OH wherein R is a branched alkyl group having a branching index of about 2.2 and having 13 carbon atoms.

Alkoxylate and Method of Manufacture

The alcohol described above is alkoxylated to produce an alcohol alkoxylate.

R—O—(C₃H₆O)ₓ(C₂H₄O)_{y}—H, by reacting with one or more alkylene oxides in the presence of an appropriate alkoxylation catalyst. The alkoxylation catalyst may be potassium hydroxide or sodium hydroxide which are commonly used commercially. Alternatively, a double metal cyanide catalyst may be used, as described in U.S. Pat. No. 6,977,236. Still further, a lanthanum-based or a rare-earth metal-based alkoxylation catalyst may be used, as described in U.S. Pat. Nos. 5,059,719 and 5,057,627. The alkoxylation reaction temperature may range from 90° C. to 250° C., preferably from 120 to 220° C., and super atmospheric pressures may be used if it is desired to maintain the alcohol substantially in the liquid state.

The alkoxylation catalyst is preferably a basic catalyst, for example a metal hydroxide, which contains a Group IA or Group IIA metal ion. When the metal ion is a Group IA metal ion, it is a lithium, sodium, potassium or cesium ion, preferably a sodium or potassium ion, and most preferably a potassium ion. When the metal ion is a Group IIA metal ion, it is a magnesium, calcium or barium ion. Examples of the alkoxylation catalyst are lithium hydroxide, sodium hydroxide, potassium hydroxide, cesium hydroxide, magnesium hydroxide, calcium hydroxide and barium hydroxide. Sodium hydroxide and potassium hydroxide are preferred catalysts and potassium hydroxide is most preferred. Other suitable alkoxylation catalysts include BF₃, SnCl₂, sodium phenolate, sodium methoxide, sodium propoxide, BF₃-etherate, p-toluene sulfonic acid, fluorosulfonic acid, aluminum butyrate and perchloric acid. The amount of the alkoxylation catalyst is of from 0.01 to 5 wt. %, preferably from 0.05 to 1 wt. %, and more preferably from 0.1 to 0.5 wt. %, based on the total weight of the catalyst, alcohol and alkylene oxide (i.e. the total weight of the final reaction mixture).

The alkoxylation procedure serves to introduce a desired average number of alkylene oxide units per mole of alcohol alkoxylate, wherein different numbers of alkylene oxide units are distributed over the alcohol alkoxylate molecules. For example, treatment of an alcohol with 13 moles of alkylene oxide per mole of primary alcohol results in the alkoxylation of each alcohol molecule with an average of 13 alkylene oxide groups, although a substantial proportion of the alcohol will have become combined with more than 13 alkylene oxide groups and an approximately equal proportion will have become combined with less than 13. In a typical alkoxylation product mixture, there may also be a minor proportion of unreacted alcohol.

In one embodiment, the alcohol is treated with a high ratio of moles of propylene oxide to moles of alcohol. For example, the ratio of moles of propylene oxide to moles of alcohol may be at least 7, preferably at least 11 and more preferably at least 13. In many instances, the aqueous solubility of sulfates made from alcohol alkoxylates having a high number of propylene oxide groups is lower than desired. The sulfation method of the invention described hereinafter can provide alcohol propoxy sulfates with a high number of propylene oxide groups while also exhibiting a satisfactory aqueous solubility.

In the above formula (I), x is the number of propylene oxide groups and is of from 1 to 80. The average value for x is of from 1 to 80, preferably of from 3 to 20, and more preferably from 3 to 16. The average number of propylene oxide groups is referred to as the average PO number. In one embodiment, the alcohol propoxylate may also contain ethoxylate groups that are added to the alcohol propoxylate by contacting it with ethylene oxide. The ethylene oxide may be added in a step after a propoxylation to provide an EO-tipped molecule or it may be added at the same time as or before the propylene oxide groups are added.

In the above formula (I), y is the number of ethylene oxide groups and is of from 0 to 20. The average value for y is of from 0 to 20, preferably of from 1 to 10, and more preferably from 2 to 5. The average number of ethylene oxide groups is referred to as the average EO number.

In one embodiment, a phenolic antioxidant is added to the alcohol alkoxylate as a stabilizer, as described in US 2017/0267914, to improve the long-term storage stability of the alcohol alkoxylate. In another embodiment, the alcohol alkoxylate is prepared according to the method described in US 2015/0307428 where the alcohol alkoxylate is contacted with a sulfonic acid.

Sulfate and Method of Manufacture

The alcohol alkoxylate R—O—(C₃H₆O)ₓ—(C₂H₄O)_{y}—H, described above, may be sulfated by any known method, for example by contacting the alcohol with a sulfating agent including sulfur trioxide, oleum, complexes of sulfur trioxide with (Lewis) bases, for example the sulfur trioxide pyridine complex and the sulfur trioxide trimethylamine complex, chlorosulfonic acid and sulfamic acid. The sulfation may be carried out at a temperature of at most 80° C. The sulfation may be carried out at temperature as low as −20° C. For example, the sulfation may be carried out at a temperature from 10 to 70° C., preferably from 20 to 60° C., and more preferably from 20 to 50° C.

The alcohol alkoxylate may be reacted with a gas mixture which in addition to at least one inert gas contains a gaseous sulfating agent. The amount of sulfating agent is such that the molar ratio of SO₃ to alcohol alkoxylate is at least 1.14:1, preferably at least 1.2:1. The molar ratio of SO₃ to alcohol alkoxylate may be in the range of from 1.2:1 to 2:1. In another embodiment, the molar ratio of SO₃ to alcohol is at least 1.3:1. Although other inert gases are also suitable, air or nitrogen are preferred.

The reaction of the alcohol with the sulfur trioxide containing inert gas may be carried out in falling film reactors. Such reactors utilize a liquid film trickling in a thin layer on a cooled wall which is brought into contact with the gas. Kettle cascades, for example, would be suitable as possible reactors. Other reactors include stirred tank reactors, which may be employed if the sulfation is carried out using sulfamic acid or a complex of sulfur trioxide and a (Lewis) base, for example the sulfur trioxide pyridine complex or the sulfur trioxide trimethylamine complex.

Following sulfation, the liquid reaction mixture may be neutralized using an aqueous alkali metal hydroxide, for example sodium hydroxide or potassium hydroxide; an aqueous alkaline earth metal hydroxide, for example magnesium hydroxide or calcium hydroxide; a base, for example ammonium hydroxide, substituted ammonium hydroxide, sodium carbonate or potassium hydrogen carbonate; or an amine, for example ethanolamine, diethanolamine, triethanolamine, triethylene tetramine, or tetraethylene pentamine. In one embodiment, a concentrated aqueous alkali hydroxide solution, for example 50% sodium hydroxide solution is used in the neutralization. The neutralization procedure may be carried out over a wide range of temperatures and pressures. For example, the neutralization procedure may be carried out at a temperature from 0 to 90° C., preferably from 45 to 65° C. and a pressure in the range from 100 to 2000 kPa.

The alcohol alkoxy sulfate may be a liquid, a waxy liquid or a solid at 20° C. It is preferred that at least 50 wt. %, preferably at least 60 wt. %, and more preferably at least 70 wt. % of the alcohol alkoxy sulfate is liquid at 20° C. Further it is preferred that of from 50 to 100 wt. %, preferably of from 60 to 100 wt. %, and more preferably of from 70 to 100 wt. % of the alcohol alkoxy sulfate is liquid at 20° C.

In addition to the main alcohol alkoxy sulfate product, the alcohol alkoxy sulfate composition produced in this step will also comprise unreacted alcohol alkoxylate and polyalkoxy mono and disulfates. The total concentration of polyalkoxy mono and disulfates (polyalkoxy sulfates) is calculated by adding the concentration of polyalkoxy disulfates, polyalkoxy hydroxy sulfates and polyalkoxy allyl sulfates. The polyalkoxy sulfates may be present in an amount of from 0.1 to 20 wt %, preferably an amount of from 2 to 20 wt %, and more preferably an amount of from 5 to 15 wt %.

The polyalkoxy sulfates may comprise polypropoxy sulfates (PPS) and may be polypropoxy disulfates (PDS), polypropoxy hydroxy sulfate (PHS) or polypropoxy allyl sulfates (PAS) and mixtures thereof. The polyalkoxy sulfates may also comprise polypropoxyethoxy sulfates. In one embodiment, the total concentration of polypropoxy sulfates may be at least 9 wt %, and preferably at least 12 wt %.

It is believed that the concentration of the unreacted alcohol alkoxylate and total polyalkoxy sulfates are affected by the molar ratio of the SO₃ to the alcohol alkoxylate in the feed to the sulfation reactor. It is also believed that lower levels of UOM and higher levels of polyalkoxy disulfates contribute to improved aqueous solubility of the alcohol alkoxy sulfate.

The alcohol alkoxy sulfate has a has a high active matter concentration which is desirable to reduce transport of water in the product, in the journey from the manufacturing site to the field project location. It is also desirable that the high active matter concentration gives a product with acceptable handleability characteristics in the context that some surfactant concentrates can be very viscous and even gel or paste like in consistency. The handleability of the surfactant is critical to its storage, transport and use in chemical enhanced oil recovery. Surfactants that do not have these characteristics are difficult to transport and use due to the difficulty in pumping and mixing.

The alcohol alkoxy sulfate mixture has an active matter concentration greater than 72 wt %, preferably greater than 75 wt %, more preferably greater than 80 wt % and eve more preferably greater than 85 wt %. The alcohol alkoxy sulfate preferably exhibits Newtonian behavior and is a flowable liquid. The viscosity of flowable alcohol alkoxy sulfate as measured in accordance with DIN 53019 at 25° C. and with a shear rate of D=10 s⁻¹ is preferably less than 10000 mPa·s, and more preferably less than 1000 mPa·s.

Use in Enhanced Oil Recovery

Hydrocarbon Recovery Composition

The alcohol alkoxy sulfate mixture described above is suitable for use as a surfactant component in a hydrocarbon recovery composition for use in chemical enhanced oil recovery. The method of treating a hydrocarbon containing formation, comprises providing a hydrocarbon recovery composition to at least a portion of the formation and allowing the hydrocarbon recovery composition to contact the formation. The hydrocarbon recovery composition comprising the alcohol alkoxy sulfate composition is typically combined with a hydrocarbon removal fluid to produce an injectable fluid, at the location of a hydrocarbon containing formation, after which the injectable fluid is injected into the hydrocarbon containing formation.

The alcohol alkoxy sulfate mixture may be transported to a hydrocarbon recovery location and stored at that location in the form of an aqueous composition containing for example 15-95 wt. % surfactant, preferably from 60-90 wt %. At the hydrocarbon recovery location, the surfactant concentration of such composition would then be further reduced to 0.05-2 wt. %, by diluting the composition with water or brine, before it is injected into a hydrocarbon containing formation. By such dilution with water or brine, an aqueous fluid is formed which can be injected into the hydrocarbon containing formation. Advantageously, a more concentrated aqueous composition having an active matter content of for example 50-90 wt. %, as described above, may be transported to the location and stored there. The active matter content of such aqueous surfactant composition is preferably at least 50 wt. %, more preferably at least 60 wt. %, more preferably at least 70 wt. %, most preferably at least 75 wt. %.

The hydrocarbon removal fluid comprises 1) water, 2) mono (e.g. Na) and/or divalent cations (e.g. Ca and Mg), and 3) anions such as chloride, bromide, iodide, bicarbonate and sulfate ions. The water may originate from the hydrocarbon containing formation or from any other source, for example river water, sea water or aquifer water. A suitable example is sea water which may contain about 1,700 ppmw of divalent cations which typically comprise calcium (Ca²⁺) and magnesium (Mg²⁺) cations. The concentration of divalent cations may be from 0 to 25,000 ppmw, and the concentration of divalent cations may vary greatly between different sources.

The salinity of the water (e.g. brine), which may originate from the hydrocarbon containing formation or from any other source, may be of from 0.5 to 30 wt. % or 0.5 to 20 wt. % or 0.5 to 10 wt. % or 1 to 6 wt. %. The term salinity refers to the concentration of total dissolved solids (% TDS), wherein the dissolved solids comprise dissolved salts. The salts may be salts comprising divalent cations, for example magnesium chloride and calcium chloride, and salts comprising monovalent cations, for example sodium chloride and potassium chloride. Sea water may have a salinity (% TDS) of 3.6 wt. %.

The total amount of the surfactants in the injectable fluid may be of from 0.05 to 2 wt. %, preferably 0.1 to 1.5 wt. %, more preferably 0.1 to 1.2 wt. %, most preferably 0.2 to 1.0 wt. %.

The injectable fluid may also comprise a polymer as further described below. The polymer may be added to the injectable fluid, or to the surfactant containing the alcohol alkoxy sulfate mixture before forming the injectable fluid. The main function of the polymer is to increase viscosity. The polymer may provide mobility control (relative to the oil phase) as the injectable fluid propagates from the injection well to the production well and stimulates the formation of an oil bank that is pushed to the production well.

Thus, the polymer should be a viscosity increasing polymer such that the polymer should increase the viscosity of an aqueous fluid in which the surfactant has been dissolved, which aqueous fluid may then be injected into a hydrocarbon containing formation. Production from a hydrocarbon containing formation may be enhanced by treating the hydrocarbon containing formation with a polymer that may mobilize hydrocarbons to one or more production wells. The polymer may reduce the mobility of the water phase, because of the increased viscosity, in pores of the hydrocarbon containing formation. The reduction of water mobility may allow the hydrocarbons to be more easily mobilized through the hydrocarbon containing formation.

Suitable polymers performing the above-mentioned function of increasing viscosity in enhanced oil recovery, for use in the present invention, and preparations thereof, are described in U.S. Pat. Nos. 6,427,268, 6,439,308, 5,654,261, 5,284,206, 5,199,490 and 5,103,909.

Suitable commercially available polymers for enhanced oil recovery include Flopaam® manufactured by SNF Floerger, CIBA® ALCOFLOOD® manufactured by Ciba Specialty Additives (Tarrytown, N.Y.), Tramfloc® manufactured by Tramfloc Inc. (Temple, Ariz.) and HE® polymers manufactured by Chevron Phillips Chemical Co. (The Woodlands, Tex.). A specific suitable polymer commercially available at SNF Floerger is Flopaam® 3630 which is a partially hydrolyzed polyacrylamide.

The nature of the polymer is not relevant in the present invention, if the polymer can increase viscosity. The molecular weight of the polymer should be sufficiently high to increase viscosity. The molecular weight of the polymer is at least 1 million Dalton, preferably at least 2 million Dalton, and more preferably at least 4 million Dalton. The maximum for the molecular weight of the polymer is not essential. The molecular weight of the polymer is at most 30 million Dalton, preferably at most 25 million Dalton.

Further, the polymer may be a homopolymer, a copolymer or a terpolymer. Still further, the polymer may be a synthetic polymer or a biopolymer or a derivative of a biopolymer. Examples of suitable biopolymers or derivatives of biopolymers include xanthan gum, guar gum and carboxymethyl cellulose.

A suitable monomer for the polymer, typically a synthetic polymer, is an ethylenically unsaturated monomer of formula R¹R²C═CR³R⁴, wherein at least one of the R¹, R², R³ and R⁴ substituents is a substituent which contains a moiety selected from the group consisting of —C(═O)NH₂, —C(═O)OH, —C(═O)OR wherein R is a branched or linear C₆-C₁₈ alkyl group, —OH, pyrrolidone and —SO₃H (sulfonic acid), and the remaining substituent(s), if any, is (are) selected from the group consisting of hydrogen and alkyl, preferably C₁-C₄ alkyl, more preferably methyl. Most preferably, the remaining substituent(s), if any, is (are) hydrogen. A polymer is preferably used that is made from an ethylenically unsaturated monomer.

Suitable examples of the ethylenically unsaturated monomer as defined above, are acrylamide, acrylic acid, lauryl acrylate, vinyl alcohol, vinylpyrrolidone, and styrene sulfonic acid and 2-acrylamido-2-methylpropane sulfonic acid. Suitable examples of ethylenic homopolymers that are made from the ethylenically unsaturated monomers are polyacrylamide, polyacrylate, polylauryl acrylate, polyvinyl alcohol, polyvinylpyrrolidone, and polystyrene sulfonate and poly(2-acrylamido-2-methylpropane sulfonate). For these polymers, the counter cation for the —C(═O)O— moiety (in the case of polyacrylate) and for the sulfonate moiety may be an alkali metal cation, for example a sodium ion, or an ammonium ion.

As mentioned above, copolymers or terpolymers may also be used. Examples of suitable ethylenic copolymers include copolymers of acrylic acid and acrylamide, acrylic acid and lauryl acrylate, and lauryl acrylate and acrylamide.

Preferably, the polymer which may be used in the present invention is a polyacrylamide, more preferably a partially hydrolyzed polyacrylamide. A partially hydrolyzed polyacrylamide contains repeating units of both —[CH₂—CHC(═O)NH₂]— and —[CH₂—CHC(═O)O⁻M⁺]— wherein M⁺ may be an alkali metal cation, for example a sodium ion, or an ammonium ion. The extent of hydrolysis is not essential and may vary within wide ranges. For example, 1 to 99 mole %, or 5 to 95 mole %, or 10 to 90 mole %, preferably 15 to 40 mole %, and more preferably 20 to 35 mole %, of the polyacrylamide may be hydrolyzed.

Hydrocarbon Containing Formation

A “hydrocarbon containing formation” is defined as a sub-surface hydrocarbon containing formation. The hydrocarbon containing formation may be a crude oil-bearing formation. Different crude oil-bearing formations or reservoirs differ from each other in terms of crude oil type. First, the API may differ among different crude oils. Further, different crude oils comprise varying amounts of saturates, aromatics, resins and asphaltenes. The four components are commonly abbreviated as “SARA”. Further, crude oils comprise varying amounts of acidic and basic components, including naphthenic acids and basic nitrogen compounds. Still further, crude oils comprise varying amounts of paraffin wax. These components are present in heavy (low API) crude oils and light (high API) crude oils. The overall distribution of such components in a crude oil is a direct result of geochemical processes. The properties of the crude oil in the crude oil-bearing formation may differ widely. For example, in respect of the API and the amounts of the above-mentioned crude oil components comprising saturates, aromatics, resins, asphaltenes, acidic and basic components (including naphthenic acids and basic nitrogen compounds) and paraffin wax, the crude oil may be of one of the types as disclosed in WO 2013030140 and US 2016/0177172.

Hydrocarbons may be produced from hydrocarbon containing formations through wells penetrating such formations. “Hydrocarbons” are generally defined as molecules formed primarily of carbon and hydrogen atoms such as oil and natural gas. Hydrocarbons may also include other elements, such as halogens, metallic elements, nitrogen, oxygen and/or sulfur. Hydrocarbons derived from a hydrocarbon containing formation may include kerogen, bitumen, pyrobitumen, asphaltenes, oils or combinations thereof. Hydrocarbons may be located within or adjacent to mineral matrices within the earth. Matrices may include sedimentary rock, sands, silicilytes, carbonates, diatomites and other porous media.

A hydrocarbon containing formation may include one or more hydrocarbon containing layers, one or more non-hydrocarbon containing layers, an overburden and/or an underburden. An overburden and/or an underburden includes one or more different types of impermeable materials. For example, overburden/underburden may include rock, shale, mudstone, or wet/tight carbonate (an impermeable carbonate without hydrocarbons). For example, an underburden may contain shale or mudstone. In some cases, the overburden/underburden may be somewhat permeable. For example, an underburden may be composed of a permeable mineral for example sandstone or limestone.

Properties of a hydrocarbon containing formation may affect how hydrocarbons flow through an underburden/overburden to one or more production wells. Properties include porosity, permeability, pore size distribution, surface area, salinity or temperature of formation. Overburden/underburden properties in combination with hydrocarbon properties, capillary pressure (static) characteristics and relative permeability (flow) characteristics may affect mobilization of hydrocarbons through the hydrocarbon containing formation.

Fluids, for example, gas, water, hydrocarbons or combinations thereof, of different densities may exist in a hydrocarbon containing formation. A mixture of fluids in the hydrocarbon containing formation may form layers between an underburden and an overburden according to fluid density. Gas may form a top layer, hydrocarbons may form a middle layer and water may form a bottom layer in the hydrocarbon containing formation. The fluids may be present in the hydrocarbon containing formation in various amounts. Interactions between the fluids in the formation may create interfaces or boundaries between the fluids. Interfaces or boundaries between the fluids and the formation may be created through interactions between the fluids and the formation. Typically, gases do not form boundaries with other fluids in a hydrocarbon containing formation. A first boundary may form between a water layer and underburden. A second boundary may form between a water layer and a hydrocarbon layer. A third boundary may form between hydrocarbons of different densities in a hydrocarbon containing formation.

Production of fluids may perturb the interaction between fluids and between fluids and the overburden/underburden. As fluids are removed from the hydrocarbon containing formation, the different fluid layers may mix and form mixed fluid layers. The mixed fluids may have different interactions at the fluid boundaries. Depending on the interactions at the boundaries of the mixed fluids, production of hydrocarbons may become difficult.

Quantification of energy required for interactions, for example mixing, between fluids within a formation at an interface may be difficult to measure. Quantification of energy levels at an interface between fluids may be determined by generally known techniques, for example using a spinning drop tensiometer. Interaction energy requirements at an interface may be referred to as interfacial tension. “Interfacial tension” as used herein, refers to a surface free energy that exists between two or more fluids that exhibit a boundary. A high interfacial tension value, for example greater than 10 mN/m, may indicate the inability of one fluid to mix with a second fluid to form a fluid emulsion. As used herein, an “emulsion” refers to a dispersion of one immiscible fluid into a second fluid by addition of a compound that reduces the interfacial tension between the fluids to achieve stability. The inability of the fluids to mix may be due to high surface interaction energy between the two fluids. Low interfacial tension values, for example less than 1 mN/m, may indicate less surface interaction between the two immiscible fluids. Less surface interaction energy between two immiscible fluids may result in the mixing of the two fluids to form an emulsion. Fluids with low interfacial tension values may be mobilized to a well bore due to reduced capillary forces and subsequently produced from a hydrocarbon containing formation. Thus, in surfactant cEOR, the mobilization of residual oil is achieved through surfactants which generate a sufficiently low crude oil/water interfacial tension (IFT) to give a capillary number large enough to overcome capillary forces and allow the oil to flow.

The mobilization of residual hydrocarbons retained in a hydrocarbon containing formation may be difficult due to the viscosity of the hydrocarbons and capillary effects of the fluids in the pores of the hydrocarbon containing formation. As used herein “capillary forces” refers to attractive forces between fluids and at least a portion of the hydrocarbon containing formation. Capillary forces may be overcome by increasing the pressures within a hydrocarbon containing formation. Capillary forces may also be overcome by reducing the interfacial tension between fluids in a hydrocarbon containing formation. The ability to reduce the capillary forces in a hydrocarbon containing formation may depend on several factors, including the temperature of the hydrocarbon containing formation, the salinity of water in the hydrocarbon containing formation, and the composition of the hydrocarbons in the hydrocarbon containing formation.

As production rates decrease, additional methods may be employed to make a hydrocarbon containing formation more economically viable. Methods may include adding sources of water, for example brine or steam, gases, polymers or any combinations thereof to the hydrocarbon containing formation to increase mobilization of hydrocarbons.

Treating the Formation

In the present invention, the hydrocarbon containing formation is treated with a surfactant(s) containing injectable fluid, as described above. Interaction of the fluid with the hydrocarbons may reduce the interfacial tension of the hydrocarbons with one or more fluids in the hydrocarbon containing formation. The interfacial tension between the hydrocarbons and an overburden/underburden of a hydrocarbon containing formation may be reduced. Reduction of the interfacial tension may allow at least a portion of the hydrocarbons to mobilize through the hydrocarbon containing formation.

The ability of the surfactant(s) containing injectable fluid to reduce the interfacial tension of a mixture of hydrocarbons and fluids may be evaluated using known techniques. The interfacial tension value for a mixture of hydrocarbons and water may be determined using a spinning drop tensiometer. An amount of the surfactant(s) containing injectable fluid may be added to the hydrocarbon/water mixture and the interfacial tension value for the resulting fluid may be determined.

The temperature of the hydrocarbon containing formation may be 25° C. or higher. The temperature may be in the range of from 25° C. to 200° C., preferably in a range of from 25° C. to 150° C., most preferably in a range of from 25° C. to 80° C. In one embodiment, the temperature of the hydrocarbon containing formation is in the range of from 80° C. to 120° C.

The method of treating a hydrocarbon containing formation comprises providing a hydrocarbon recovery composition to at least a portion of the hydrocarbon containing formation and allowing the hydrocarbon recovery composition to contact the formation wherein the hydrocarbon recovery composition comprises alcohol alkoxy sulfates and polyalkoxy sulfates.

### EXAMPLES

### Example 1

In this example, the viscosity, physical state and rheological behavior of surfactants were measured and observed. The surfactants that were used are commercially available surfactants available from Shell Chemical LP as ENORDET J771, ENORDET J11111, ENORDET J13131, and ENORDET A771. ENORDET J771 is a C12,C13-7PO sulfate; ENORDET J11111 is a C12,C13-11PO sulfate; ENORDET J13131 is a C12,C13-13PO sulfate, and ENORDET A771 is a C16,C17-7PO sulfate. From each batch of surfactants, the individual surfactant mixtures were diluted as needed to prepare a surfactant mixture having the desired active matter concentration.

For handleability, including mixing and pumping, it is highly preferable for the surfactants to be a flowable liquid which is not too viscous and which is more Newtonian in rheological behavior instead of being a soft gel and/or exhibiting highly non-Newtonian or shear thinning behavior.

Table 1 shows the viscosity of each surfactant sample, measured at 25° C. at a 10 s⁻¹ shear rate. Table 1 also characterizes the physical state of the surfactant sample and rheological behavior at 25° C. This temperature was used as it is preferred for the material to exhibit good handleability characteristics at ambient temperature. It is expected that the viscosity and rheology of the surfactants will also be affected by the temperature.

TABLE 1

| | | Total | | | |
|---|---|---|---|---|---|
| | Alcohol | Active | | | |
| | Propoxy | Matter | Viscosity | | Rheological |
| Batch | Sulfate | (wt %) | (mPa · s) | Physical State | Behaviour |
| 1 | J771 | 70 | 4,780 | Flowable Soft Gel | Newtonian |
| 1 | J771 | 76 | 623 | Viscous Flowable Liquid | Shear Thinning |
| 2 | J771 | 70 | 7,920 | Semi-Flowable Soft Gel | Shear Thinning |
| 2 | J771 | 76 | 597 | Viscous Flowable Liquid | Newtonian |
| 3 | J13131 | 70 | 3,480 | Flowable Soft-Gel | Shear Thinning |
| 3 | J13131 | 72 | 1,833 | Flowable Soft Gel | Shear Thinning |
| 3 | J13131 | 75 | 750 | Viscous Flowable Liquid | Newtonian |
| 4 | J11111 | 70 | 3,790 | Flowable Soft Gel | Shear Thinning |
| 4 | J11111 | 75 | 562 | Viscous Flowable Liquid | Newtonian |
| 4 | J11111 | 82 | 1,110 | Viscous Flowable Liquid | Newtonian |
| 5 | J11111 | 70 | 459 | Viscous Flowable | Slightly Shear |
| | | | | Liquid/Flowable Soft Gel | Thinning |
| 5 | J11111 | 75 | 621 | Viscous Flowable Liquid | Newtonian |
| 6 | A771 | 82 | 1044 | Viscous Flowable Liquid | Newtonian |

As can be seen from the data, these surfactants exhibit poor behavior (as shown by the shear thinning behavior and/or being a soft gel) when the total active matter is 70 wt % for the J13131 and J771 cases. When the total active matter of these surfactants is greater than 70 wt %, especially higher than 72 wt %, the surfactants demonstrate good behavior (as shown by the Newtonian behavior and/or being a flowable liquid). It is believed that surfactants having even higher active matter concentrations will exhibit improved viscosity, rheological behavior and physical state. In the case of select batches of the ENORDET J11111 (Batch 5) surfactant the higher viscosity regime is expected to be at <70 wt % though the desirable, relatively low viscosity and largely Newtonian behavior is the same (as for J13131, J771) between 70-82 wt %.

### Example 2

This example demonstrates the distribution of components that contribute to the total active matter of the surfactant mixture. It is known in the industry that the measurement of total active matter, involving titration of all the anionic species in the alcohol alkoxy sulfate composition with a cationic titrant, gives the sum of alcohol alkoxy sulfate concentration plus anionic by-products. The total active matter is determined by titrating the mixture (titration method is based on ASTM D4251-89 and ASTM D6173-97). With regards to alcohol propoxy sulfate compositions, the anionic by-products include the polypropoxy sulfates (PPS). These polypropoxy sulfates can be polypropoxy disulfate (PDS), polypropoxy hydroxy sulfate (PHS) and polypropoxy allyl sulfates (PAS).

The mixtures were prepared by alkoxylating and then sulfating a C12/C13 alcohol under a variety of conditions. Table 2 shows the respective amounts of surfactants contributing to the active matter of the mixture. The wt % of the different alcohol propoxy sulfate species (C9-11, C12-18 and C19-C20) and total polypropoxy sulfate (PPS) species in the titratable total active matter were determined by Time of Flight Mass Spectrometry (ToF-MS).

TABLE 2

| | C9-C11 | C12-C18 | C19-C20 | | |
|---|---|---|---|---|---|
| | Alcohol | Alcohol | Alcohol | | |
| | Propoxy | Propoxy | Propoxy | | |
| | Sulfate, | Sulfate, | Sulfate, | Total PPS, | Total AM |
| Batch | AM (wt %) | AM (wt %) | AM (wt %) | AM (wt %) | (wt %) |
| A | 0.1 | 69.9 | 0.0 | 7.1 | 77.1 |
| B | 0.0 | 69.0 | 0.0 | 6.8 | 75.9 |
| C | 0.1 | 70.6 | 0.0 | 6.4 | 77.1 |
| D | 0.2 | 72.8 | 0.0 | 6.2 | 79.1 |
| E | 0.2 | 64.9 | 0.0 | 5.5 | 70.6 |
| F | 0.2 | 66.2 | 0.0 | 6.5 | 72.8 |
| G | 0.2 | 66.9 | 0.0 | 7.7 | 74.7 |
| H | 0.2 | 68.0 | 0.0 | 7.5 | 75.7 |
| I | 0.2 | 73.2 | 0.0 | 3.0 | 76.4 |
| J | 0.2 | 70.7 | 0.0 | 4.7 | 75.5 |
| K | 0.2 | 67.6 | 0.0 | 6.8 | 74.6 |
| L | 0.2 | 73.1 | 0.0 | 8.3 | 81.6 |
| M | 0.0 | 79.9 | 0.3 | 2.1 | 82.2 |

As can be seen from this data, the total titratable active matter of the surfactant samples is made up from the alcohol propoxy sulfate components and the polypropoxy sulfate components. Batch C in this Example is from the same batch identified as Batch 3 in Example 1. Batch I in this Example is from the same batch identified as Batch 1 in Example 1. Batch J in this Example is from the same batch identified as Batch 2 in Example 1. Batch K in this Example is from the same batch identified as Batch 5 in Example 1. Batch L in this Example is from the same batch identified as Batch 4 in Example 1. Batch M in this Example is from the same batch identified as Batch 6 in Example 1.

That which is claimed is:

1. A composition comprising from 60-80 wt % alcohol alkoxy sulfates, 2-20 wt % of polyalkoxy sulfates and water wherein the alcohol alkoxy sulfates are of the formula R—O—(C₃H₆O)ₓ—(C₂H₄O)_{y}—SO₃ where R is an alkyl group having from 9 to 18 carbon atoms, x is from 1 to 40, y is from 0 to 20 and x+y is from 1 to 60.

2. The composition of claim 1 wherein x is from 3 to 16.

3. The composition of claim 1 wherein y is from 1 to 5.

4. The composition of claim 1 wherein the alcohol alkoxy sulfates comprises alcohol propoxy ethoxy sulfates and the polyalkoxy sulfates comprise polypropoxy sulfates and/or polypropoxyethoxy sulfates.

5. The composition of claim 1 wherein the alcohol alkoxy sulfates comprise alcohol propoxy sulfates and the polyalkoxy sulfates comprise polypropoxy sulfates.

6. The composition of claim 1 wherein the polyalkoxy sulfates comprise polypropoxy sulfates and/or polypropoxyethoxy sulfates.

7. The composition of claim 4 wherein the polypropoxy sulfates are selected from the group consisting of polypropoxy disulfate (PDS), polypropoxy hydroxy sulfate (PHS), polypropoxy allyl sulfates and mixtures thereof.

8. The composition of claim 1 wherein the concentration of alcohol alkoxy sulfates is from 65 to 78 wt %.

9. The composition of claim 1 further comprising from 0.1 to 10 wt % of alcohol alkoxylates.

10. The composition of claim 1 wherein the total titratable active matter is greater than 75%.

11. The composition of claim 1 wherein the total titratable active matter is greater than 80%.

12. The composition of claim 1 wherein the composition is flowable at 25° C. and has a viscosity of less than 10000 mPa·s measured in accordance with DIN 53019 at 25° C. and with a shear rate of D=10 s⁻¹.

13. The composition of claim 1 wherein the composition is flowable at 25° C. and has a viscosity of less than 1000 mPa·s measured in accordance with DIN 53019 at 25° C. and with a shear rate of D=10 s⁻¹.

14. The diluted composition comprising an aqueous diluent and the composition of claim 1 wherein the diluted composition comprises from 0.05-2 wt % of the composition.

15. The diluted composition of claim 12 wherein the aqueous solubility limit of the diluted composition is at least 3 wt % NaCl after 24 hours at room temperature.

16. The method of producing the composition of claim 1 comprising sulfating an alcohol propoxylate by contacting the alcohol propoxylate with a sulfating agent under sulfation conditions wherein the sulfation conditions comprise feeding the sulfating agent at a molar ratio of SO₃ to alcohol propoxylate of greater than 1:1.

17. The method of claim 14 wherein the sulfation conditions comprise feeding the sulfating agent at a molar ratio of SO₃ to alcohol propoxylate of at least 1.2:1.

18. The method of claim 14 wherein the sulfation conditions comprise feeding the sulfating agent at a molar ratio of SO₃ to alcohol propoxylate of from 1.2:1 to 2:1.

19. The method of claim 14 wherein the sulfating agent is selected from the group consisting of sulfur trioxide, complex of sulfur trioxide with bases, chlorosulfonic acid and sulfamic acid.

20. The method of claim 17 wherein the complex of sulfur trioxide with a base is selected from the group consisting of sulfur trioxide pyridine complex and sulfur trioxide trimethylamine complex.

21. The method of claim 14 wherein the sulfating agent is sulfur trioxide.

22. The method of claim 14 wherein the sulfation conditions comprise a temperature in the range of from 10 to 70° C.

23. A method of treating a hydrocarbon containing formation comprising providing a hydrocarbon recovery composition to at least a portion of the hydrocarbon containing formation and allowing the hydrocarbon recovery composition to contact the formation wherein the hydrocarbon recovery composition comprises a mixture of:
a. 0.05 to 2 wt % of a composition comprising from 60-80 wt % alcohol alkoxy sulfates and 2-20 wt % of polyalkoxy sulfates wherein the alcohol alkoxy sulfates are of the formula R—O—(C₃H₆O)ₓ(C₂H₄O)_{y}—SO₃ where R is an alkyl group having from 9 to 18 carbon atoms, x is from 1 to 40, y is from 0 to 20 and x+y is from 1 to 60; and
b. 60 to 98 wt % water and/or brine.
